(19) United States
(12) Patent Application Publication
(10) Pub. No.: US 2005/0143089 A1
(43) Pub. Date: Jun. 30, 2005

(54) Location aided cell search

(75) Inventors: Martin J. Dowling, Plymouth Meeting, PA (US); Kenneth E. Bartsch, Lititz, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/747,298

(22) Filed: Dec. 29, 2003

(51) Int. Cl. H04Q 7/20; H04B 7/00

(52) U.S. Cl. 455/456.1; 455/440; 455/525

(57) ABSTRACT

Positions of a wireless transmit/receive unit (WTRU) are determined over time. The determined positions are used to determine a movement direction of the WTRU. Based on a current position of the determined positions and the movement direction of the WTRU, at least one cell that the WTRU is approaching is identified. Information is sent to the WTRU for the identified at least one cell. The information for the identified at least one cell is used to reduce the complexity of cell search.

### FIELD OF INVENTION

The invention generally relates to wireless communication systems. In particular, the invention relates to cell search in such systems.

### BACKGROUND

In cell search, a wireless transmit/receive unit (WTRU) identifies and begins synchronization with a cell of a wireless network. This procedure uses extensive resources of the WTRU.

To illustrate, in the proposed third generation partnership project (3GPP) universal mobile telecommunications system (UMTS) for wideband code division multiple access (W-CDMA), a three step process is used for cell search. In the first step, the WTRU searches for primary synchronization code (PSC) locations in a radio frame. Each cell within the system transmits a PSC. In the second step, the WTRU uses the PSC locations to detect secondary synchronization codes (SSCs). The SSCs indicate certain cell specific information. In the third step, the WTRU either identifies the scrambling code of the common pilot channel (CPICH), for frequency division duplex (FDD) mode, or the midamble of the broadcast channel (BCH), for time division duplex (TDD) mode of one or multiple cells. After completing cell search, the WTRU synchronizes with one of the detected cells.

As a WTRU moves, it may move between cells. To facilitate the handover between cells, the WTRU performs cell search to synchronize with new cells. Due to the complex nature of cell search, this procedure is undesirable. This procedure consumes a considerable amount of memory, power, and processing time, and is susceptible to false detection.

Accordingly, it is desirable to have alternate approaches to facilitate handover.

### SUMMARY

Positions of a wireless transmit/receive unit (WTRU) are determined over time. The determined positions are used to determine a movement direction of the WTRU. Based on a current position of the determined positions and the movement direction of the WTRU, at least one cell that the WTRU is approaching is identified. Information is sent to the WTRU for the identified at least one cell. The information for the identified at least one cell is used to reduce the complexity of cell search.

### BRIEF DESCRIPTION OF THE DRAWING(S)

FIG. 1 is a simplified diagram of an embodiment for a location aided cell search system.

FIG. 2 is an illustration of a movement vector with respect to cells.

FIG. 3 is an illustration of known transportation routes in conjunction with cells.

FIG. 4 is a flow diagram of location aided cell search.

### DETAILED DESCRIPTION OF THE PREFERRED EMBODIMENT(S)

Location aided cell search can be applied to many wireless communication systems. Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a base station, Node-B, site controller, access point or other interfacing device in a wireless environment.

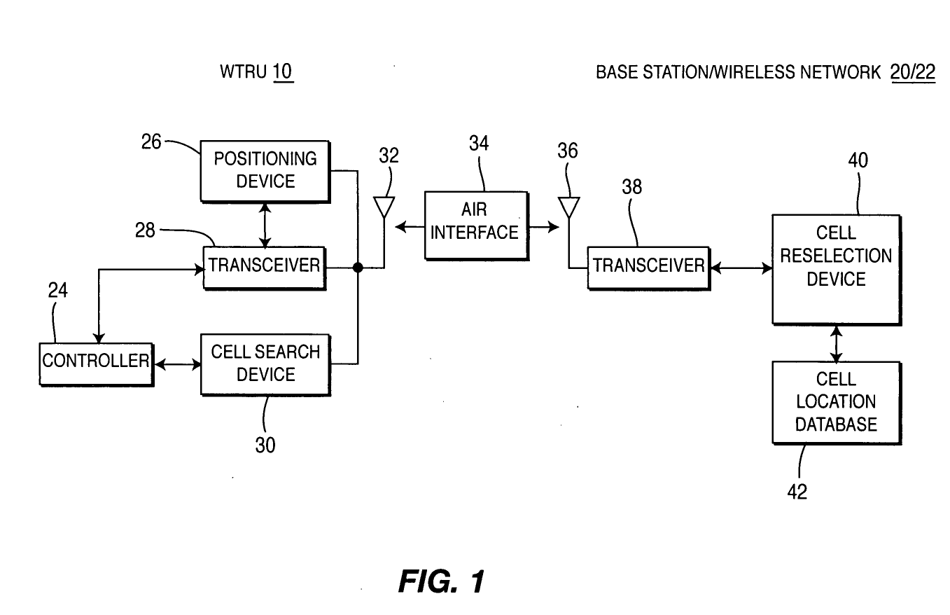

FIG. 1 is a simplified illustration of a location aided cell search system. A WTRU 10 communicates with a base station 20 and the wireless network 22 of the base station 20, via an air interface 34. The WTRU 10 has a transceiver 28 and an antenna/antenna array 32 for receiving and transmitting signals using the air interface 34. A positioning device 26 is used to determine the geographic location of the WTRU 10. The positioning device 26 may use the global positioning satellite (GPS) system or a cellular based positioning system to determine the location. Although the positioning device 26 is shown at the WTRU 10, the positioning device in alternate embodiments may be located at the base station 20/wireless network 22. In many cellular based systems, the base station 20/wireless network 22 utilize time difference of arrival (TDOA) and time of arrival (TOA) calculations and the correlation of this information can be performed at the base station 20/wireless network 22. The positioning information is sent to the base station 20, such as by a signal or message. A cell search device 30 is used to perform cell search. A controller 24 is used to control the cell search device 30.

The base station 20/wireless network 22 receives the positioning information from the WTRU 10, such as by a transceiver 38 and antenna/antenna array 36. The positioning information is received by a cell reselection device 40. The cell reselection device 40 uses the position information to determine a movement vector (indicating speed and direction) for the WTRU 10. In a 3GPP UMTS system, typically the cell reselection device 40 is located at a radio network controller (RNC), although it may be located at the Node-B, core network or other places. The movement vector is determined from the change in the WTRU position over time. The movement vector used may be the most current vector from the latest two position estimates, an averaging over multiple estimates may be used or a weighted average may be used. Preferably, the movement vector, position information and cell operating areas are constructed using a horizontal plane model (two dimensional), although a three dimensional model can be used with some increased complexity.

Using a stored cell location database 42 and the position and vector of the WTRU 10, the cell reselection device 40 determines which cell or cells that the WTRU 10 is moving towards. Using the position and vector of the WTRU 10, a trajectory of the WTRU 10 is determined. Using that trajectory, cells along or close to that trajectory are determined.

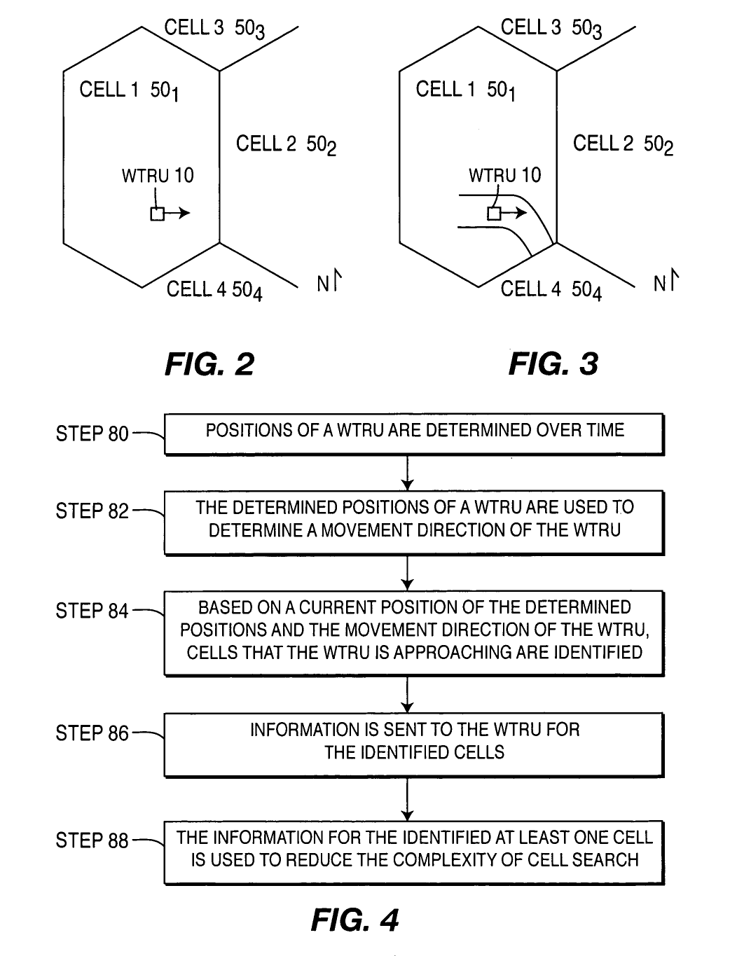

FIG. 2 is an illustration of such a scenario. A WTRU 10, located in cell 1 50₁, is traveling east towards an eastern cell (cell 2 50₂). In this scenario, the cell reselection device 40 may send the WTRU 10 cell information for cell 2 50₂, cell 3 50₃ and cell 4 50₄.

The cell reselection device 40 may also use known transportation routes, such as highways, railroads, etc., to estimate the most likely cell that the WTRU 10 is moving towards. The positions of the WTRU 10 are compared to a known location of a transportation routes to determine whether the WTRU 10 is traveling along that route. One approach is to measure a distance of a locust of position points of a WTRU 10 from the route and see whether the distances are below a threshold.

The cell reselection device 40 may also use statistical information of past WRTU behavior to estimate the most likely cell that the WTRU 10 is moving towards. The cell location database 42 may include a compilation of destination cells for various WRTU positions and direction of travel. Accessing cell relation database 42, the cell reselection device 40 determines the probability of the WRTU 10 entering each neighbor cell, and can signal the most likely next cell information to the WTRU 10.

To illustrate as shown in FIG. 3, a WTRU 10 may be moving east towards an eastern cell (cell 2 50₂), but the road that the WTRU 10 is on will shortly take a sudden turn towards the south and towards a southern cell (cell 4 50₄). The cell reselection device 40 uses this transportation route information to determine the cell or cells that the WTRU 10 is traveling towards.

The cell reselection device 40 sends cell information to the WTRU 10 for the cells that the WTRU 10 is traveling towards. Information for these cells is relayed to the WTRU 10 through the air interface 34. In the TDD mode of W-CDMA, the cell reselection device 40 may send the frequency and the “cell parameter.” In the FDD mode of W-CDMA, the cell reselection device 40 may send the cell frequency and primary scrambling code of the CPICH.

The cell information is sent to the WTRU 10 using the base station and WTRU transceivers 28, 38, via the air interface 34. The controller 24 receives the cell information and simplifies the traditional cell search procedure using this information. To illustrate, the midamble shifts for two TDD cells may be sent to a WTRU 10. The WTRU 10 uses the midamble shifts to select one of the two TDD cells to use and decode that cell's BCH. Essentially, this information skips the first and second steps of cell search, which is highly desirable. The first step of cell search has large memory requirements and the second step is susceptible to an erroneously detected or not detected SSC. Accordingly, the handover between the cells is performed more efficiently.

Alternately, the WTRU 10 may be sent cell identifiers for the cells that it is moving towards. Using the cell identifiers, the WTRU 10 can eliminate other cells from the traditional cell search algorithms. As a result, the accuracy of cell search can be improved by discarding information from the eliminated cells in the cell search procedure, both simplifying the process and reducing the chances of a false detection of an eliminated cell.

FIG. 4 is a flow diagram of location aided cell search. Positions of a WTRU are determined over time, step 80. The determined positions are used to determine a movement direction of the WTRU, step 82. Based on a current position of the determined positions and the movement direction of the WTRU, the Cell Reselection Device 40 identifies cells that the WTRU is approaching, step 84. Information is sent to the WTRU for the identified cells, step 86. The information for the identified at least one cell is used to reduce the complexity of cell search, step 88.

1. A method comprising:
determining positions of a wireless transmit/receive unit (WTRU) over time;
using the determined positions, determining a movement direction of the WTRU;
based on a current position of the determined positions and the movement direction of the WTRU, identifying at least one cell that the WTRU is approaching;
sending information to the WTRU for the identified at least one cell; and
using the information for the identified at least one cell to simplify cell search.

2. The method of claim 1 wherein the information is parameters of the identified cells.

3. The method of claim 2 wherein the WTRU is in a time division duplex wideband code division multiple access communication system and the parameters of the identified at least one cell are cell parameters.

4. The method of claim 2 wherein the WTRU is in a frequency division duplex wideband code division multiple access communication system and the parameters of the identified at least one cell are frequency and primary scrambling codes of a common pilot channel.

5. The method of claim 1 wherein the identifying cells is also based on known transportation routes.

6. The method of claim 5 wherein the identifying at least one cell includes determining a trajectory of the WTRU along at least one of the known transportation routes and the identified at least one cell is a cell along the at least one known transportation route.

7. The method of claim 6 wherein the determining a trajectory of the WTRU along at least one of the know transportation routes includes comparing a plurality of the position determinations to a location of the at least one known transportation route and based on the comparison determining whether the WTRU is using the at least one known transportation route.

8. The method of claim 1 wherein the determining the movement vector extrapolates the movement vector using the determined positions and time differences between the determined positions.

9. The method of claim 1 wherein the identifying at least one cell includes extrapolating a trajectory of the WTRU and determining which at least one cell is located near that trajectory.

10. The method of claim 1 wherein the sent information includes a cell identifier for each identified cell and the simplifying of cell search comprises eliminating cells that a cell identifier was not sent from consideration in cell search.

11. The method of claim 1 wherein the identifying at least one cell includes estimating a likelihood of approaching the at least one cell based on historical records of destination cells of WTRUs moving from a specified location and with a specified direction of travel.

12. A base station comprising:
a transceiver for receiving determined positions of a wireless transmit/receive unit (WTRU) over time;
a cell reselection device for using the determined positions to determine a movement direction of the WTRU; for based on a current position of the determined positions and the movement direction of the WTRU, identifying at least one cell that the WTRU is approaching; and
the transceiver for sending information to the WTRU for the identified at least one cell.

13. The base station of claim 12 wherein the information is parameters of the identified cells.

14. The base station of claim 13 wherein the WTRU is in a time division duplex wideband code division multiple access communication system and the parameters of the identified at least one cell are cell parameters.

15. The base station of claim 13 wherein the WTRU is in a frequency division duplex wideband code division multiple access communication system and the parameters of the identified at least one cell are frequency and primary scrambling codes of the common pilot channel.

16. The base station of claim 11 wherein the identifying cells is also based on known transportation routes.

17. The base station of claim 16 wherein the identifying at least one cell includes determining a trajectory of the WTRU along at least one of the known transportation routes and the identified at least one cell is a cell along the at least one known transportation route.

18. The base station of claim 17 wherein the determining a trajectory of the WTRU along at least one of the know transportation routes includes comparing a plurality of the position determinations to a location of the at least one known transportation route and based on the comparison determining whether the WTRU is using the at least one known transportation route.

19. The base station of claim 12 wherein the determining the movement vector extrapolates the movement vector using the determined positions and time differences between the determined positions.

20. The base station of claim 12 wherein the identifying at least one cell includes extrapolating a trajectory of the WTRU and determining which at least one cell is located near that trajectory.

21. The base station of claim 12 wherein the sent information includes a cell identifier for each identified cell.

22. The base station of claim 12 wherein the identifying at least one cell includes estimating a likelihood of approaching the at least one cell based on historical records of destination cells of WTRUs moving from a specified location and with a specified direction of travel.

23. A wireless transmit/receive unit (WTRU) comprising:
a positioning device for determining positions of the WTRU over time;
a transceiver for transmitting the determined positions and for receiving information for at least one cell identified that the WTRU is moving towards; and
a controller for using the information for the identified at least one cell to simplify cell search performed by a cell search device.

24. The WTRU of claim 23 wherein the information is parameters of the identified cells.

25. The WTRU of claim 23 wherein the WTRU is in a time division duplex wideband code division multiple access communication system and the parameters of the identified at least one cell are cell parameters.

26. The WTRU of claim 23 wherein the WTRU is in a frequency division duplex wideband code division multiple access communication system and the parameters of the identified at least one cell are frequency and primary scrambling codes of a common pilot channel.

27. The WTRU of claim 22 the information includes a cell identifier for each identified cell and the controller simplifies cell search comprises by eliminating cells that a cell identifier was not sent from consideration in cell search.
